(19) United States
(12) Patent Application Publication
(10) Pub. No.: US 2009/0198879 A1
(43) Pub. Date: Aug. 6, 2009

(54) MEMORY SYSTEM AND METHOD OF CONTROLLING THE SAME

(75) Inventor: Tatsuya Tanaka, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/366,327

(22) Filed: Feb. 5, 2009

(30) Foreign Application Priority Data
Feb. 5, 2008 (JP) 2008-024749

(51) Int. Cl. G06F 12/02

(52) U.S. Cl. 711/103; 711/E12.008

(57) ABSTRACT

A memory system has a memory unit composed of a plurality of memory cells, a memory controller for controlling to read out and write data from and to the memory unit, and a host processor connected to the memory controller for reading out and writing data from and to the memory unit through the memory controller. The memory controller has a refresh controller for rewriting the data stored in the memory unit. The host processor has a determination unit for determining whether or not a refresh operation can be executed to the memory unit and a permission signal transmission unit for transmitting a refresh permission signal when it is determined that the refresh operation can be executed to the memory unit by the determination unit. The refresh controller controls the start of the refresh operation to the memory unit based on the refresh permission signal transmitted from the host processor.

### CROSS REFERENCE TO RELATED APPLICATIONS

This application is based on and claims the benefit of priority from prior Japanese Patent Application No. 2008-24749, filed on Feb. 5, 2008, the entire contents of which are incorporated herein by reference.

### BACKGROUND OF THE INVENTION

1. Field of the Invention

The present invention relates to a memory system in which data is electrically rewritable and a control method thereof, and more particularly to a memory system having a memory unit for storing data and a memory controller for controlling data read/write and a control method thereof.

2. Description of the Related Art

A NAND flash memory is known as one of electrically rewritable non-volatile semiconductor storage devices (EEPROM: Electrically Erasable Programmable Read Only Memory). Since the NAND flash memory has a unit cell area smaller than that of a NOR flash memory, the capacity of the NAND flash memory can be easily increased compared to a NOR flash memory. Further, although the NAND flash memory has a read/write speed in a cell unit slower than that of the NOR type flash memory, it can read and write data at substantially a high speed by increasing a cell range (physical page length) in which data is read and written at the same time between a cell array and a page buffer. The NAND flash memory is used as various recording media such as a file memory and a memory card making use of the above features.

The NAND flash memory reads out data per memory cell transistors which share a word line. A unit of the memory cell transistors is called a page. Further, the unit of memory cell transistors which share all the word lines between a drain side selection gate line and a source side selection gate line is called a block. Data is read by applying a voltage according to the level of data to be read out to a control gate of a selected memory cell transistor and applying an increased high voltage to control gates of the memory cell transistors in the same block as that of the selected memory cell transistor. The data is read out by conducting the memory cell transistors other than the selected memory cell transistor and detecting whether or not a current flows to the selected memory cell transistor.

In the NAND flash memory, the non-selected memory cell transistors are used as transfer gates in a read-out operation. In the read-out operation, a relatively high voltage is applied to the word lines, and the non-selected memory cell transistors from which no data is read out are placed in a weak write state. When this operation is repeated, the data stored in the memory cell transistors can be inverted.

Further, data written to a memory cell transistor is identified by the amount of charge trapped by floating gates, charge accumulation layers, and the like insulated from peripheral component. However, since a minute charge leaks from the floating gate and the like for trapping the charge, the trapped charge gradually decreases as time passes. As a result, the data stored in the memory cell transistors may be inverted as a time passes.

As a method of preventing the inversion of the data stored in the memory cell transistors as described above, there is proposed a (refreshing) method of reading out the data of memory cell transistors and writing the data to different cells (refer to, for example, Japanese Patent Application Laid-Open Publication No. 8-279295).

In various electronic equipment in which a NAND flash memory is built in, a processor including a control unit of the NAND flash memory (hereinafter, referred to as memory controller) controls to read out and write data from and to the NAND flash memory. The controller manages data on how many times data is read out from a specific memory cell transistor of the NAND flash memory or data on how long time passes after data is written to the specific memory cell transistor is managed by the memory controller. The memory controller refreshes the data stored in the NAND flash memory based on the number of times of read or on the time elapsed after the write of data.

Data is newly written to and read out from the NAND flash memory to a host processor as external electronic equipment. When the memory controller refreshes the NAND flash memory while the data is written and read out, the write/read operation, which the host processor intends to execute, is executed after the refresh operation is finished. The write/read operation is waited until the memory controller finishes the refresh operation. Therefore, a problem arises in that the performance of the write/read operation, which the host processor intends to execute, is deteriorated.

### SUMMARY OF THE INVENTION

A memory system according to an aspect of the present invention has a memory unit composed of a plurality of memory cells in which data can be electrically rewritable, a memory controller for controlling to read out and write data from and to the memory unit, and a host processor connected to the memory controller for reading out and writing data from and to the memory unit through the memory controller, the memory controller comprising a refresh controller for rewriting the data stored in the memory unit, and the host processor comprising a determination unit for determining whether or not a refresh operation can be executed to the memory unit, and a permission signal transmission unit for transmitting a refresh permission signal when it is determined that the refresh operation can be executed to the memory unit by the determination unit, and the refresh controller controlling the start of the refresh operation to the memory unit based on the refresh permission signal transmitted from the host processor.

A memory system according to another aspect of the present invention has a memory unit composed of a plurality of memory cells in which data can be electrically rewritable, a memory controller for controlling to read out and write data from and to the memory unit, and a host processor connected to the memory controller for reading out and writing data from and to the memory unit through the memory controller, the memory controller comprising a refresh controller for rewriting the data stored in the memory unit, and a request signal transmission unit for transmitting a refresh start request signal to the host processor to request the host processor to start a refresh operation, and the host processor comprising a determination unit for determining whether or not the refresh operation can be executed to the memory unit after the host processor receives the refresh start request signal, and a permission signal transmission unit for transmitting a refresh permission signal when it is determined that the refresh operation can be executed to the memory unit by the determination unit, and the refresh controller controlling the start of the refresh operation to the memory unit based on the refresh permission signal transmitted from the host processor.

A control method of a memory system according to an aspect of the present invention has a memory unit composed of a plurality of memory cells in which data can be electrically rewritable, a memory controller for controlling to read out and write data from and to the memory unit, and a host processor connected to the memory controller for reading out and writing data from and to the memory unit through the memory controller, the control method comprising determining whether or not the data stored in the memory unit can be rewritten by the host processor, transmitting a refresh permission signal from the host processor when it is determined that the refresh operation can be executed to the memory unit, and controlling the start of the refresh operation to the memory unit by the memory controller based on the refresh permission signal transmitted from the host processor.

### BRIEF DESCRIPTION OF THE DRAWINGS

FIG. 1 is a block diagram showing an arrangement of a memory system according to a first embodiment;

FIG. 2 is a circuit diagram showing a cell array arrangement of a memory core unit of a NAND flash memory;

FIG. 3 is a flowchart describing a refresh operation of the first embodiment;

FIG. 4 is a block diagram showing an arrangement of a memory system according to a second embodiment; and

FIG. 5 is a flowchart describing a refresh operation of the second embodiment.

### DETAILED DESCRIPTION OF THE EMBODIMENTS

Embodiments of a memory system according to the present invention will be described referring to drawings.

### First Embodiment

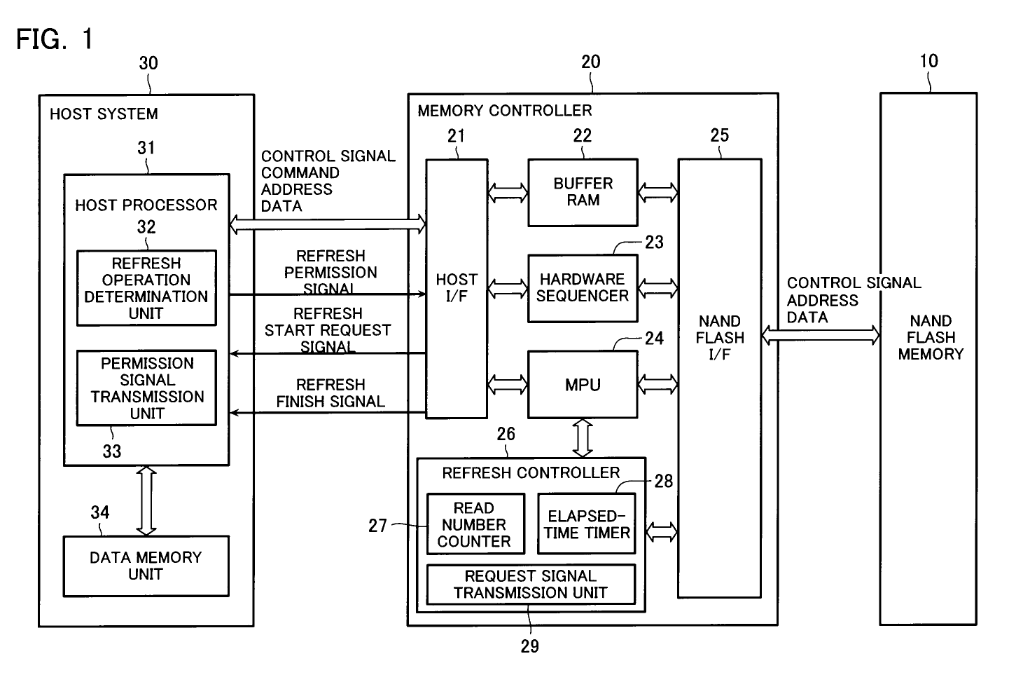

FIG. 1 is a block diagram showing an arrangement of a memory system according to a first embodiment. The memory system of the embodiment has a NAND flash memory 10 and a memory controller 20 for controlling data read/write from and to the NAND flash memory 10. Further, the memory system has a host system 30 connected to the memory controller 20 for executing data read/write from and to the NAND flash memory 10 through the memory controller 20.

For example, one or a plurality of the NAND flash memories 10 are mounted on the memory system, and each of them is composed of one or a plurality of memory chips.

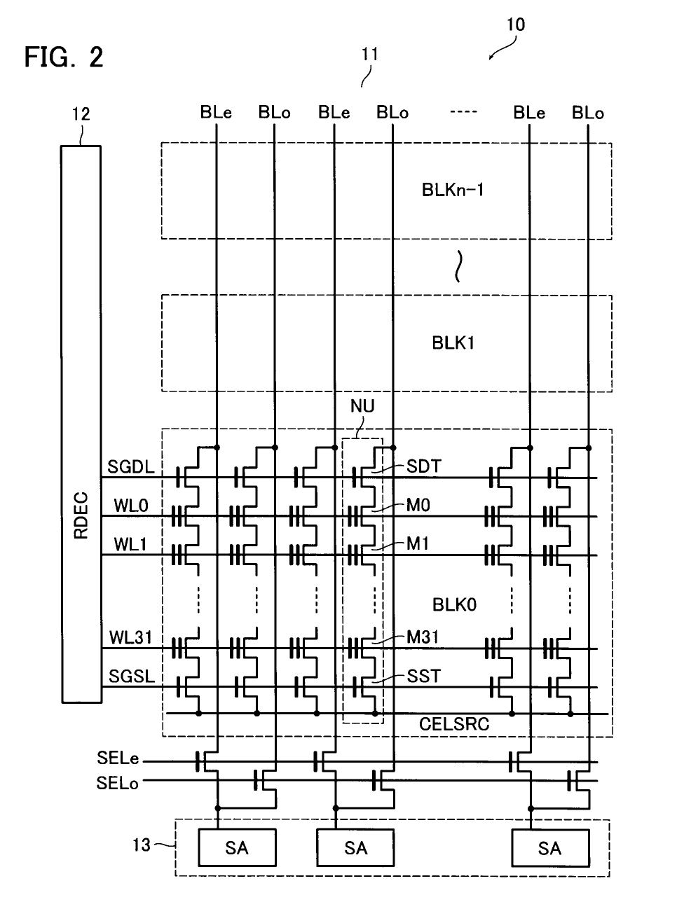

FIG. 2 is a circuit diagram showing an arrangement of a cell array of a memory core unit of the NAND flash memory 10 of FIG. 1. The memory cell array 11 is composed by disposing NAND cell units (NAND strings) NU, which is formed by a plurality of electrically rewritable non-volatile memory cell transistors (32 memory cell transistors in an example of FIG. 2) M0-M31 connected in series. One end of the NAND cell units NU is connected to bit lines BLo or BLe through drain side selection gate transistors SDT, and the other end thereof is connected to a common source line CELSRC through source side selection gate transistors SST. Control gates of the memory cell transistors M0-M31 are connected to word lines WL0-WL31, respectively, and the selection gate transistors SDT, SST have gates connected to a drain side selection gate line SGDL and a source side selection gate line SGSL, respectively.

A sense amplifier circuit 13, which is used for reading out and writing data from and to the memory cell transistors, is disposed to one end of the bit lines BLe or BLo. A row decoder 12, which selects and drives the word lines and the selection gate lines, is disposed to one end of the word lines. FIG. 2 shows a case in which the even bit lines BLe and the odd bit lines BLo, which are alternately arranged each other, are selectively connected to respective sense amplifier SA of the sense amplifier circuit 13 by a bit line selection circuit.

The source side selection gate line SGSL and the drain side selection gate line SGDL are used to turn on and off the selection transistors SST, SDT. When data is written and read, the source side selection transistors SST and the drain side selection transistors SDT function as gates for supplying a certain electric potential to the memory cell transistors M0-M31 in the unit.

A group of the NAND cell units NU aligned in a word line direction constitutes a block as a minimum unit for erasing data, and a plurality of blocks BLK0-BLKn-1 are disposed in a bit line direction as shown in the drawing. A plurality of memory cell transistors connected to the same word line WL in one block are handled as one page, and a data write/read operation is executed for each page.

The memory controller 20 shown in FIG. 1 has a host interface 21, a buffer RAM (Random Access Memory) 22, a hardware sequencer 23, a MPU (Micro Processing Unit) 24, and a NAND flash interface 25. The host interface 21 transfers a control signal, a command, an address, and data between the memory controller 20 and a host processor 31 to be described later. The buffer RAM 22 temporarily stores the read/write data and the like transferred from the host processor 31. The hardware sequencer 23 is used for sequence control and the like to read/write firmware (FW) in the NAND flash memory 10. The MPU 24 controls to transfer data in the memory controller 20. The NAND flash interface 25 transfers a control signal, an address, and data between the memory controller 20 and the NAND flash memory 10. Further, the memory controller 20 has a refresh controller 26 for controlling a refresh operation of the NAND flash memory 10.

The refresh controller 26 has a read number counter 27, an elapsed-time timer 28, and a request signal transmission unit 29. The read number counter 27 measures the number of times data are read from the NAND flash memory 10. The number of times the data are read may be measured by cumulating the number of times data read-out control signals are transmitted to the NAND flash memory 10 or by cumulating the number of times data are read from each block constituting the memory cell array 11 of the NAND flash memory 10 based on an address and a control signal for reading out data. When a measured data read-out number of times Ri is equal to or exceeds a certain reference read-out number of times Rr, the read number counter 27 transmits a certain signal to the request signal transmission unit 29. The elapsed-time timer 28 measures the time elapsed from the time at which a data write operation was executed to the NAND flash memory 10. When a measured elapsed-time T1 is equal to or exceeds a certain reference elapsed-time Tr, the elapsed-time timer 28 transmits a certain signal to the request signal transmission unit 29. Although both the read number counter 27 and the elapsed-time timer 28 are disposed to the embodiment, only any one of them may be disposed. When the request signal transmission unit 29 receives a signal indicating that the reference read-out number of times Rr or the reference elapsed-time Tr, which is transmitted from at least any one of the read number counter 27 and the elapsed-time timer 28 is exceeded, it transmits a refresh start request signal to the host processor 31 through the MPU 24.

The host system 30 has the host processor 31 and a data memory unit 34. The host processor 31 writes various types of data stored in the data memory unit 34 to the NAND flash memory 10 and reads data from the NAND flash memory 10 based on an instruction from a not shown input apparatus. The data memory unit 34 is a recording medium in which various types of data read from and written to the NAND flash memory 10 are stored.

The host processor 31 has a refresh operation determination unit 32 and a permission signal transmission unit 33. After the refresh operation determination unit 32 of the embodiment receives the refresh start request signal from the refresh controller 26, it determines whether or not the refresh operation of the data stored in the NAND flash memory 10 can be started. The refresh operation determination unit 32 determines that the refresh operation can be started when a read/write operation is not executed to the NAND flash memory 10. In addition, the refresh operation determination unit 32 also determines that the refresh operation can be started even when a read/write operation is under way, as far as the buffer RAM 22 can store data, and thus a read/write performance is not deteriorated. Further, the refresh operation determination unit 32 determines that the refresh operation cannot be started when the read/write operation is executed to the NAND flash memory 10 and the read/write performance is deteriorated when the refresh operation is executed. When the refresh operation determination unit 32 determines that the refresh operation can be started to the NAND flash memory 10, the permission signal transmission unit 33 transmits a refresh start permission signal to the refresh controller 26 through the MPU 24. Further, when the refresh operation determination unit 32 determines that the refresh operation cannot be started to the NAND flash memory 10, a busy signal may be transmitted to the refresh controller 26 through the MPU 24.

The read/write operation in the memory system arranged as described above will be described. A command, an address (logic address or physical address), data, and external control signals such as a chip-enable signal, a write enable signal, a read-out enable signal, a ready/busy signal, and the like are input to a host interface 21. In the host interface 21, the command and the control signals are selectively supplied to the MPU 24 and the hardware sequencer 23 as well as the address and the data are stored in the buffer RAM 22.

The logic address input from the outside is converted to the physical address of the NAND flash memory 10 by the NAND flash interface 25. Further, a data transfer control and a data read/write sequence control are executed under the control of the hardware sequencer 23 based on various types of control signals. The converted physical address is transferred to the row decoder 12 and a column decoder (not shown) through an address register in the NAND flash memory 10. Write data is loaded to the sense amplifier circuit 13 through a not shown I/O control circuit and the like and stored in the respective memory cell transistors M0-M31 of the memory cell array 11. Further, read data is output to the outside through the I/O control circuit and the like.

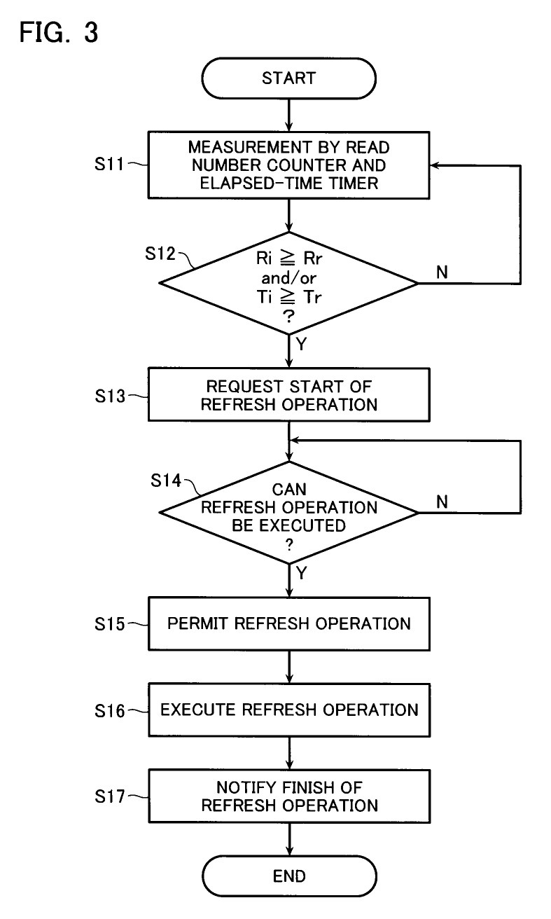

The refresh operation of the memory system of the embodiment will be described using a flowchart shown in FIG. 3.

The memory system shown in FIG. 1 starts the refresh operation of the data stored in the NAND flash memory 10 by, for example, turning on a power supply. At step S11, the refresh controller 26 measures the read-out number of times Ri of the data stored in the NAND flash memory 10 by the read number counter 27, and the elapsed-time T1 of the data after it is written by the elapsed-time timer 28.

At step S12, the read number counter 27 and the elapsed-time timer 28 compare the read-out number of times Ri and the elapsed-time T1 with the reference read-out number of times Rr and the reference elapsed-time Tr which are previously set. The process goes to step S13 when any one or both of the read-out number of times Ri and the elapsed-time T1 are equal to or larger than the certain values and the refresh operation is necessary. When any one or both of the read-out number of times Ri and the elapsed-time T1 are smaller than the certain values, the process returns to step S11 and measures the read-out number of times Ri and the elapsed-time T1 from writing again.

At step S13, when any one or both of the read-out number of times Ri and the elapsed-time T1 are equal to or larger than the certain values, the refresh controller 26 requests the host processor 31 to start the refresh operation. The request for starting the refresh operation is executed by transmitting the refresh start request signal from the request signal transmission unit 29. The request for starting the refresh operation may also be notified by transmitting a specific command to the host processor 31 or changing the electric potential level of a specific signal.

At step S14, the refresh operation determination unit 32 of the host processor 31 determines whether or not the refresh operation can be executed to the NAND flash memory 10. When the refresh operation can be executed, the process goes to next step S15. When the read/write operation is executed to the NAND flash memory 10 and the refresh operation can not be executed, the host processor 31 determines again whether or not the refresh operation can be executed after a certain waiting time elapses and the like.

At step S15, when the refresh operation can be executed, the host processor 31 permits the refresh controller 26 to execute the refresh operation. The permission for starting the refresh operation is executed by transmitting a refresh permission signal from the permission signal transmission unit 33. The permission for starting the refresh operation may also be notified by transmitting a specific command to the host processor 26 or changing the electric potential level of a specific signal.

At step S16, after the refresh controller 26 receives the refresh permission signal, the refresh operation of the NAND flash memory 10 is executed by the refresh controller 26.

At step S17, the refresh controller 26 transmits a refresh finish signal to the host processor 31 to show that the refresh operation of the NAND flash memory 10 is finished. The finish of the refresh operation may also be notified by transmitting a specific command to the host processor 31 or changing the electric potential level of a specific signal. When the refresh operation of the NAND flash memory 10 is finished, the values measured by the read number counter 27 and the elapsed-time timer 28 are reset. With this operation, the refresh operation of the memory system is finished.

When a refresh operation is executed to a NAND flash memory in a conventional memory system, a busy signal is transmitted from a memory controller to a host processor, and data is neither read out nor written. Further, when it is instructed to start the refresh operation at the time the data is read out and written, reading-out and writing of the data is temporarily interrupted. With this operation, a data read/write performance is deteriorated.

In the embodiment, when the read/write operation is executed from the host processor 31 to the NAND flash memory 10 and the read/write performance is deteriorated by executing the refresh operation, the memory controller 20 does not start the refresh operation. When the refresh operation is executed, a timing at which the performance of the write/read operation to the NAND flash memory 10 is not deteriorated is selected by the host processor 31. Accordingly, the deterioration in the performance of the write/read operation caused by the refresh operation can be prevented.

### Second Embodiment

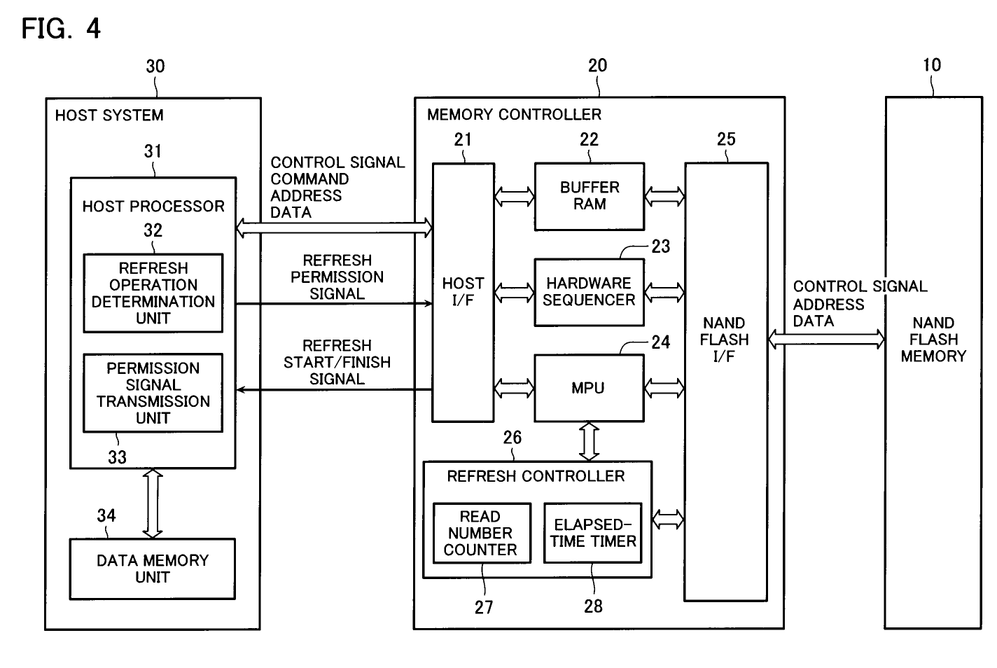

Next, a second embodiment of the present invention will be described. FIG. 4 is a block diagram showing an arrangement of a memory system according to the second embodiment. The portions having the same arrangements as those of the first embodiment are denoted by the same reference numerals and the explanation thereof is omitted.

The memory system according to the second embodiment is different from that of the first embodiment in that a refresh operation determination unit 32 determines whether or not a refresh operation of a NAND flash memory 10 can be started at all times without receiving a refresh start request signal from a refresh controller 26. When the refresh operation determination unit 32 determines that the refresh operation can be started to the NAND flash memory 10, a permission signal transmission unit 33 continuously transmits a refresh start permission signal to the refresh controller 26 through an MPU 24. The start of the refresh operation is permitted by changing the electric potential level of a specific signal to a memory controller 20. Further, the memory system according to the second embodiment is also different from the first embodiment in that it does not have a request signal transmission unit 29.

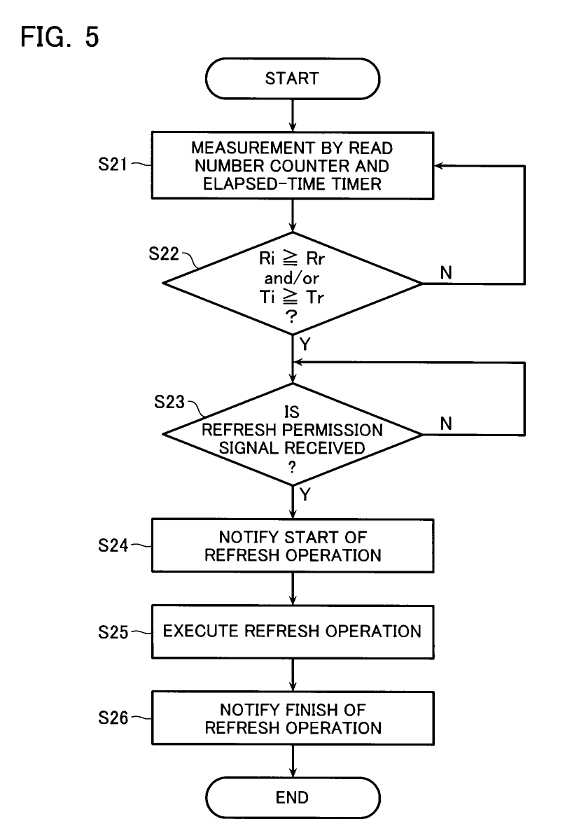

The refresh operation of the memory system of the embodiment will be described using a flowchart shown in FIG. 5.

The memory system shown in FIG. 4 starts the refresh operation of the data stored in the NAND flash memory 10 by, for example, turning on a power supply. At step S21, the refresh controller 26 measures a read-out number of times Ri of the data stored in the NAND flash memory 10 by a read number counter 27, and an elapsed-time T1 of the data after it is written by an elapsed-time timer 28.

At step S22, the read number counter 27 and the elapsed-time timer 28 compare the read-out number of times Ri and the elapsed-time T1 with a reference read-out number of times Rr and a reference elapsed-time Tr which are previously set. The process goes to next step S23 when any one or both of the read-out number of times Ri and the elapsed-time T1 are equal to or larger than the certain values and the refresh operation is necessary. When any one or both of the read-out number of times Ri and the elapsed-time T1 are smaller than the certain values, the process returns to step S21 and measures the read-out number of times Ri and the elapsed-time T1 from writing again.

At step S23, when any one or both of the read-out number of times Ri and the elapsed-time T1 are equal to or larger than the certain values, the refresh controller 26 examines whether or not the refresh permission signal is transmitted. The examination of the refresh permission signal can be executed by detecting the change of the electric potential level of the specific signal to the memory controller 20. When a refresh permission signal is transmitted from the host processor 31, the process goes to next step S24. When the refresh permission signal is not transmitted from the host processor 31, the refresh controller 26 examines again whether or not the refresh permission signal is transmitted after a certain waiting time elapses and the like.

At step S24, when the refresh permission signal is transmitted from the host processor 31, the refresh controller 26 transmits a refresh start signal to the host processor 31 to indicate to start the refresh operation. The start of the refresh operation may be notified by transmitting a specific command to the host processor 31 or changing the electric potential level of a specific signal.

At step S25, after the refresh start signal is transmitted, the refresh operation of the NAND flash memory 10 is executed by the refresh controller 26.

At step S26, the refresh controller 26 transmits a refresh finish signal to the host processor 31 to show that the refresh operation of the NAND flash memory 10 is finished. The finish of the refresh operation may be notified by transmitting a specific command to the host processor 31 or changing the electric potential level of a specific signal. When the refresh operation of the NAND flash memory 10 is finished, the values measured by the read number counter 27 and the elapsed-time timer 28 are reset. With this operation, the refresh operation of the memory system is finished.

Also in the embodiment, when a read/write operation is executed from the host processor 31 to the NAND flash memory 10 and a read/write performance is deteriorated by executing the refresh operation, the memory controller 20 does not start the refresh operation. When the refresh operation is executed, a timing at which the performance of the write/read operation to the NAND flash memory 10 is not deteriorated is selected by the host processor 31. Accordingly, the deterioration in the performance of the write/read operation caused by the refresh operation can be prevented.

The refresh operation determination unit 32 of the embodiment determines that the refresh operation is started without receiving a refresh start request signal from the memory controller 20. Accordingly, an internal arrangement of the memory controller 20 can be simplified without providing a request signal transmission unit 29 in the refresh controller 26.

Although the embodiments of the present invention has been described above, the present invention is not limited thereto, and various changes, additions, combinations, and the like are possible within a scope which does not depart from the gist of the present invention.

What is claimed is:

1. A memory system comprising:
a memory unit composed of a plurality of memory cells in which data can be electrically rewritable;
a memory controller for controlling to read out and write data from and to the memory unit; and
a host processor connected to the memory controller for reading out and writing data from and to the memory unit through the memory controller,
the memory controller comprising a refresh controller for rewriting the data stored in the memory unit, and
the host processor comprising
a determination unit for determining whether or not a refresh operation can be executed to the memory unit, and
a permission signal transmission unit for transmitting a refresh permission signal when it is determined that the refresh operation can be executed to the memory unit by the determination unit, and
the refresh controller controlling the start of the refresh operation to the memory unit based on the refresh permission signal transmitted from the host processor.

2. The memory system according to claim 1 further comprising a read number counter for measuring the number of times of a read operation from the memory unit,
wherein the refresh controller controls the start of the refresh operation to the memory unit based on the refresh permission signal after the value measured by the read number counter exceeds a certain value.

3. The memory system according to claim 2 further comprising a request signal transmission unit for transmitting a refresh start request signal for requesting the host processor to start the refresh operation after the value measured by the read number counter exceeds a certain value,
wherein the determination unit determines whether or not the refresh operation can be executed to the memory unit after the refresh start request signal is received.

4. The memory system according to claim 2, wherein the read number counter measures the number of times data is read out by cumulating the number of times a data read-out control signal is transmitted to the memory unit.

5. The memory system according to claim 2, wherein the read number counter measures the number of times data is read out by cumulating the number of times data is read out in each block constituting a memory cell array of the memory unit based on a data read address and a data read-out control signal.

6. The memory system according to claim 2 further comprising an elapsed time timer for measuring the time elapsed from the time at which a write operation is executed to the memory unit,
wherein the refresh controller controls the start of the refresh operation to the memory unit based on the refresh permission signal after the value measured by the read number counter and the value measured by the elapsed time timer exceed certain values.

7. The memory system according to claim 6 further comprising a request signal transmission unit for transmitting a refresh start request signal for requesting the host processor to start the refresh operation after the value measured by the read number counter and the value measured by the elapsed time timer exceed certain values,
wherein the determination unit determines whether or not the refresh operation can be executed to the memory unit after the refresh start request signal is received.

8. The memory system according to claim 1 further comprising an elapsed time timer for measuring the time elapsed from the time at which a write operation is executed to the memory unit,
wherein the refresh controller controls the start of the refresh operation to the memory unit based on the refresh permission signal after the value measured by the elapsed time timer exceeds a certain value.

9. The memory system according to claim 8 further comprising a request signal transmission unit for transmitting a refresh start request signal for requesting the host processor to start the refresh operation after the value measured by the elapsed time timer exceeds a certain value,
wherein the determination unit determines whether or not the refresh operation can be executed to the memory unit after the refresh start request signal is received.

10. The memory system according to claim 1, wherein the determination unit determines that the refresh operation can be executed when a read/write operation is not executed to the memory unit or when the read/write operation is executed, but the performance of the read/write operation is not deteriorated.

11. The memory system according to claim 1, wherein:
the determination unit determines whether or not the refresh operation of the memory unit can be started at all times; and
the permission signal transmission unit continuously transmits the refresh permission signal when the determination unit determines that the refresh operation can be executed to the memory unit.

12. A memory system comprising:
a memory unit composed of a plurality of memory cells in which data can be electrically rewritable;
a memory controller for controlling to read out and write data from and to the memory unit; and
a host processor connected to the memory controller for reading out and writing data from and to the memory unit through the memory controller,
the memory controller comprising
a refresh controller for rewriting the data stored in the memory unit, and
a request signal transmission unit for transmitting a refresh start request signal to the host processor to request the host processor to start a refresh operation, and
the host processor comprising
a determination unit for determining whether or not the refresh operation can be executed to the memory unit after the host processor receives the refresh start request signal, and
a permission signal transmission unit for transmitting a refresh permission signal when it is determined that the refresh operation can be executed to the memory unit by the determination unit, and
the refresh controller controlling the start of the refresh operation to the memory unit based on the refresh permission signal transmitted from the host processor.

13. The memory system according to claim 12, wherein the determination unit determines that the refresh operation can be executed when a read/write operation is not executed to the memory unit or when the read/write operation is executed, but the performance of the read/write operation is not deteriorated.

14. The memory system according to claim 12, wherein:
the determination unit determines whether or not the refresh operation of the memory unit can be started at all times; and
the permission signal transmission unit continuously transmits the refresh permission signal when the determination unit determines that the refresh operation can be executed to the memory unit.

15. A control method of a memory system comprising a memory unit composed of a plurality of memory cells in which data can be electrically rewritable, a memory controller for controlling to read out and write data from and to the memory unit, and a host processor connected to the memory controller for reading out and writing data from and to the memory unit through the memory controller, the control method comprising:
determining whether or not the data stored in the memory unit can be rewritten by the host processor;
transmitting a refresh permission signal from the host processor when it is determined that the refresh operation can be executed to the memory unit; and
controlling the start of the refresh operation to the memory unit by the memory controller based on the refresh permission signal transmitted from the host processor.

16. The control method of the memory system according to claim 15, wherein the start of the refresh operation of the memory unit is controlled based on the refresh permission signal after the number of times of a read operation from the memory unit exceeds a certain value.

17. The control method of the memory system according to claim 16 further comprising transmitting a refresh start request signal for requesting the host processor to start the refresh operation from the memory controller after the number of times of the read operation exceeds a certain value;
wherein the host processor determines whether or not the refresh operation can be executed to the memory unit after the host processor receives the refresh start request signal.

18. The control method of the memory system according to claim 15, wherein the start of the refresh operation of the memory unit is controlled based on the refresh permission signal after the time elapsed from the time at which a write operation is executed to the memory unit exceeds a certain value.

19. The control method of the memory system according to claim 18 further comprising transmitting a refresh start request signal for requesting the host processor to start the refresh operation from the memory controller after the time elapsed from the time at which a write operation is exacted to the memory unit exceeds a certain value;
wherein the host processor determines whether or not the refresh operation can be executed to the memory unit after the host processor receives the refresh start request signal.

20. The control method of the memory system according to claim 15, wherein the host processor determines that the refresh operation can be executed when a read/write operation is not executed to the memory unit or when the read/write operation is executed, but the performance of the read/write operation is not deteriorated.
